(19) United States
(12) Patent Application Publication
(10) Pub. No.: US 2026/0100533 A1
(43) Pub. Date: Apr. 9, 2026

(54) ELECTRICAL CONNECTOR WITH AN IMPROVED TERMINAL

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: Fang-Jwu Liao, New Taipei (TW); Jia-Hau Liu, New Taipei (TW)

(21) Appl. No.: 19/351,532

(22) Filed: Oct. 7, 2025

(30) Foreign Application Priority Data
Oct. 9, 2024 (CN) 202411400255.7

(51) Int. Cl. H01R 13/432; H01R 12/71; H01R 13/24; H01R 13/50

(52) U.S. Cl. CPC H01R 13/432; H01R 13/2435; H01R 13/50; H01R 12/714

(57) ABSTRACT

An electrical connector includes: an insulating housing having an upper face, a lower face, and plural terminal grooves penetrating the upper face and the lower face; and plural terminals retained in corresponding terminal grooves, each terminal includes a main portion having a vertical plate, an upper elastic portion, an upper contacting portion, and an upper abutting portion extending upward sequentially, a lower elastic portion, a lower contacting portion and a lower abutting portion extending downward sequentially from the vertical plate, the vertical plate has a left side face and a right side face, an upper supporting portion and a lower supporting portion protrude rightward from the right side face of the vertical plate, and the upper abutting portion abuts against the upper supporting portion and the lower abutting portion abuts against the lower supporting portion when the upper elastic portion and the lower elastic portion are pressed.

### BACKGROUND OF THE INVENTION

### Field of the Invention

The present invention relates to an electrical connector for connecting a chip module to a circuit board.

### Description of Related Arts

FIGS. 1-2 illustrate an electrical connector for connecting a chip module to a circuit board. The electrical connector comprises an insulating housing and plural terminals retained in the insulating housing. The terminal comprises a main portion for fixing the terminal in the insulating housing, an upper elastic arm and a lower elastic arm extending from the main portion. The main portion comprises a first vertical plate 31, a second vertical plate 32, and a connecting portion connecting the first vertical plate 31 with the second vertical plate 32. The upper elastic arm has an upper elastic portion 33, an upper abutting portion 34, and an upper contacting portion 35 extending upwardly from the first vertical plate 31. The main portion has an upper supporting portion 321 extending upwardly from the second vertical plate 32. The upper abutting portion 34 contacts with the upper supporting portion 321 when the upper contacting portion 35 is pressed. As both the upper abutting potion 34 and the upper supporting portion 321 are arc-shaped and are located roughly in a horizontal direction perpendicular to an up-down direction, it is hard for the upper supporting portion 321 to contact with the upper abutting potion 34 when the upper elastic arm is pressed in the up-down direction.

Therefore, it is desired to provide an electrical connector with an improved terminal.

### SUMMARY OF THE INVENTION

An object of the present invention is to provide an electrical connector with an improved terminal.

To achieve the above object, an electrical connector comprises: an insulating housing having an upper face, a lower face, and a plurality of terminal grooves penetrating the upper face and the lower face; and a plurality of terminals retained in corresponding terminal grooves, wherein each of the terminals comprises a main portion having a vertical plate, an upper elastic portion, an upper contacting portion, and an upper abutting portion extending upward sequentially from the vertical plate, a lower elastic portion, a lower contacting portion and a lower abutting portion extending downward sequentially from the vertical plate, the upper abutting portion extends downward from the upper contacting portion and the lower abutting portion extends upward from the lower contacting portion, the vertical plate has a left side face and a right side face, an upper supporting portion and a lower supporting portion protrude rightward from the right side face of the vertical plate, and the upper abutting portion abuts against the upper supporting portion and the lower abutting portion abuts against the lower supporting portion when the upper elastic portion and the lower elastic portion are pressed.

Other advantages and novel features of the invention will become more apparent from the following detailed description of the present embodiment when taken in conjunction with the accompanying drawings.

### BRIEF DESCRIPTION OF THE DRAWING

FIG. 1 is a cross-sectional view of an electrical connector in a prior art;

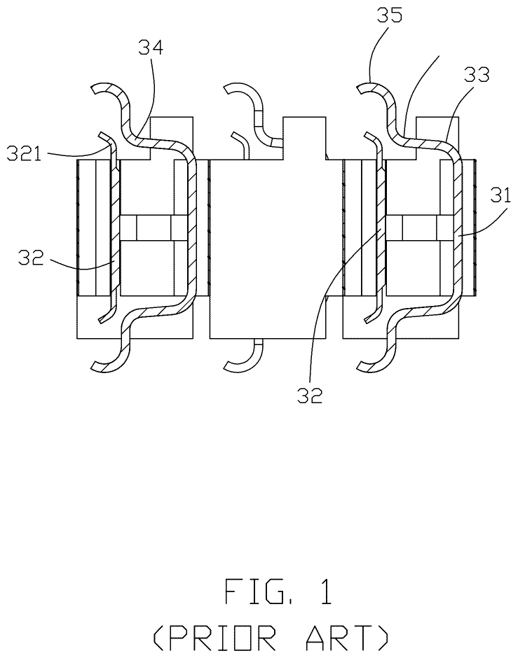

FIG. 2 is a perspective view of a terminal of the electrical connector in FIG. 1;

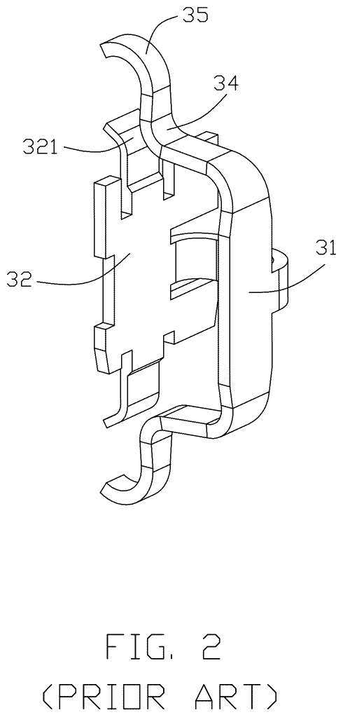

FIG. 3 is a perspective view of an electrical connector in this embodiment;

FIG. 4 is a perspective view of a terminal in FIG. 3;

FIG. 5 is another perspective view of the terminal in FIG. 4;

FIG. 6 is a right side elevational view of the terminal in FIG. 4;

FIG. 7 is a left side elevational view of the terminal in FIG. 4;

FIG. 8 is a top plan view of the terminal in FIG. 6;

FIG. 9 is a front elevational view of the terminal in FIG. 4; and

FIG. 10 is a front elevational view of the terminal in FIG. 9 when the terminal is pressed.

### DETAILED DESCRIPTION OF THE PREFERRED EMBODIMENT

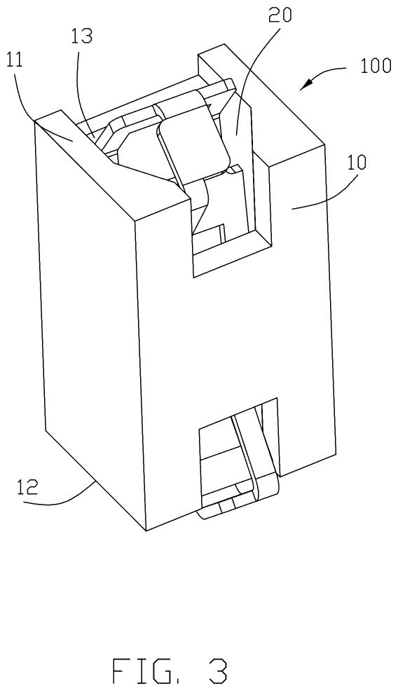

Referring to FIG. 3, an electrical connector 100 adapted for electrically connecting a chip module to a circuit board or electrically connecting two circuit boards. The electrical connector 100 comprises an insulating housing 10 and plural terminals 20, the insulating housing 10 has an upper face 11, a lower face 12 and plural terminal grooves 13 penetrating the upper face 11 and the lower face 12. The terminals 20 are retained in the corresponding terminal grooves 13 one by one. In the embodiment, only one terminal 20 and the corresponding terminal groove 13 where the terminal 20 is received is shown while the real product of the electrical connector 100 has hundreds terminals 20 that are arranged in matrix.

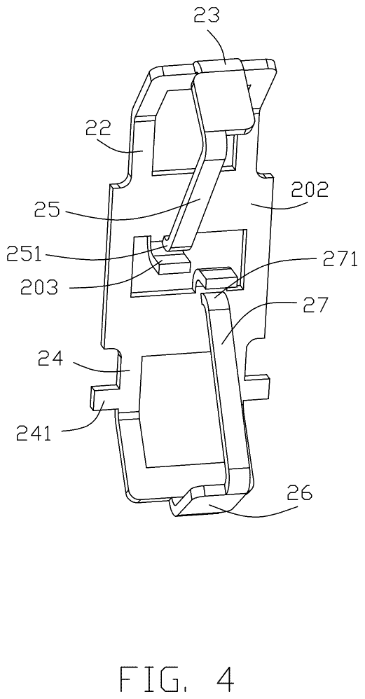

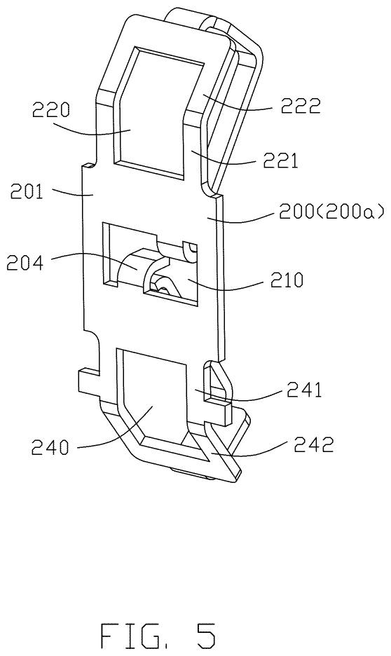

Referring to FIGS. 4-5, the terminals 20 are stamped from a metal plate. Each terminal includes a main portion 200, an upper elastic arm and a lower elastic arm extending from the main portion 200 respectively. The upper elastic arm comprises an upper elastic portion 22, an upper contacting portion 23 and an upper abutting portion 25 extending upward from the main portion 200 sequentially, the lower elastic arm has a lower elastic portion 24, a lower contacting portion 26 and a lower abutting portion 27 extending downward from the main portion 200 sequentially. In the embodiment, preferably, the main portion 200 has a vertical plate 200a, the upper elastic portion 22 extends from an upper edge of the vertical plate 200a, and the lower elastic portion 24 extends from a lower edge of the vertical plate 200a, the upper abutting portion 25 extends from the upper contacting portion 23 downwardly and the lower abutting portion 27 extends from the lower contacting portion 26 upwardly. The vertical plate 200a has a left side face 201 and a right side face 202 opposite to the left side face 201. The main portion 200 has an upper supporting portion 203 and a lower supporting portion 204 that both protrude from the right side face 202 respectively. Preferably, the upper supporting portion 203 bends from the vertical plate 200a first and then extends horizontally in a left-right direction perpendicular to the vertical plate 200a, and thus, the upper supporting portion 203 and the lower supporting portion 204 are perpendicular to the vertical plate 200a. Preferably, the upper supporting portion 203 bends rightward from the vertical plate 200a first and then extends horizontally in a right direction.

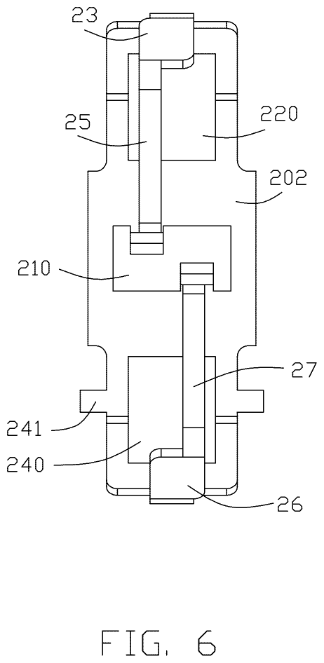

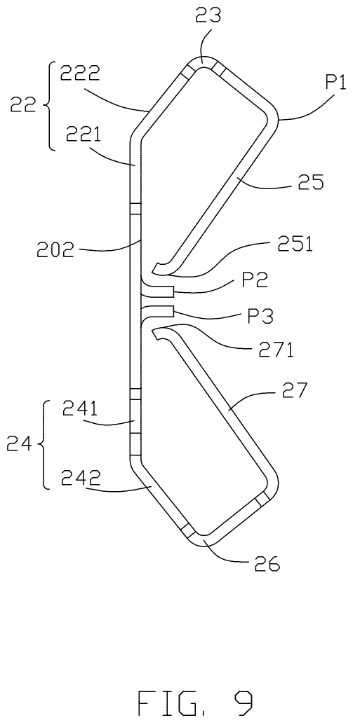

Referring to FIGS. 4-5 and 9-10, preferably, the upper elastic portion 22 extends upward and rightward as a whole from the vertical plate 200a, and thus, the upper contacting portion 23 is located at an upper right of the vertical plate 200a. The upper abutting portion 25 extends leftward toward the right side face 202 of the vertical plate 200a at the same time when the upper abutting portion 25 extends downward from the upper contacting portion 23, that is, the upper abutting portion 25 inclines leftward and downward toward the right side face 202 of vertical plate 200a. The lower abutting portion 27 extends leftward toward the right side face 202 of the vertical plate 200a at the same time when the lower abutting portion 27 extends upward from the lower contacting portion 26, that is, the lower abutting portion 27 inclines upward and leftward toward the right side face 202 of the vertical plate 200a. A rightmost point P1 of the upper elastic arm exceeds a rightmost point P2 of the upper supporting portion 203 in a right direction. Similarly, a rightmost point of the lower elastic arm exceeds a rightmost point P3 of the lower supporting portion 203 in the right direction, and thus, the length of the upper supporting portion 203 and the lower supporting portion 204 can be as short as possible. The upper abutting portion 25 abuts against an upper face of the upper supporting portion 203 and the lower abutting portion 27 abuts against a lower face of the lower supporting portion 204 when the upper contacting portion 23 and the lower contacting portion 26 move toward the insulating housing 10 or the upper contacting portion 23 and the lower contacting portion 26 are pressed. It should be noted that the words “upper”, “lower”, “left” and “right” in the invention are merely used for a convenient description of the connector and should not be construed as a limitation of a specification and claims of the embodiment. Further combining with FIG. 6, the vertical plate 200a has a slot 210 which penetrates the left side face 201 and the right side face 202. The upper supporting portion 203 extends from an upper edge of the slot 210 and is located directly below the upper abutting portion 25 and the lower supporting portion 204 bends from a lower edge of the slot 210 and is located directly above the lower abutting portion 27. Preferably, the upper supporting portion 203 bends from the upper edge of the slot 210 downward and rightward and then extends horizontally along the right direction. Similarly, the lower supporting portion 204 bends from the lower edge of the slot 210 upward and rightward and then extends horizontally along the right direction.

Referring to FIG. 4 and FIG. 6, the upper supporting portion 203 and the lower supporting portion 204 are offset and staggered from each other along a width direction (a front and rear direction) of the vertical plate 200a without overlapping when viewed from a direction perpendicular to the vertical plate 200a. A width of the upper contacting portion 23 is greater than a width of the upper abutting portion 25 and a width of the lower contacting portion 26 is greater than a width of the lower abutting portion 27. The upper abutting portion 25 extends downward from a first side edge of the upper contacting portion 23 and the lower abutting portion 27 extends upward from a second side edge of the lower contacting portion 26 that is away from the first side edge of the upper contacting portion 23 in the width direction of the vertical plate 200a, making the upper abutting portion 25 and the lower abutting portion 27 offset and staggered from each other along the width direction of the vertical plate 200a. A corresponding side edge of the upper abutting portion 25 is flush with the first side edge of the upper contacting portion 23 and a corresponding side edge of the lower abutting portion 27 is flush with the second side edge of the lower contacting portion 26. Both a free end of the upper abutting portion 25 and a free end of the lower abutting portion 27 are spoon shaped, that is, the upper abutting portion 25 has an upper spoon-shaped contacting portion 251, and the lower abutting portion 27 has a lower spoon-shaped contacting portion 271. Both the upper spoon-shaped contacting portion 251 and the lower spoon-shaped contacting portion 271 bend inwardly toward the right side face 202 of the vertical plate 200a. The upper supporting portion 203 is at a higher level relative to the lower supporting portion 204.

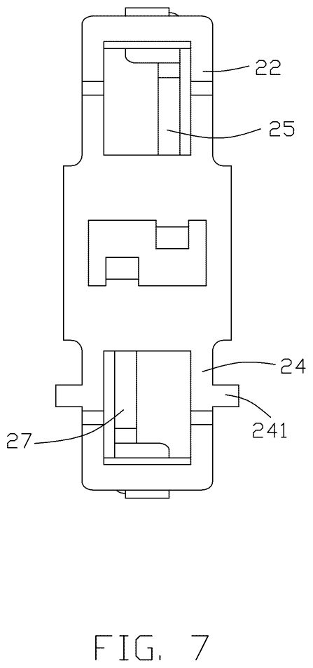

Further combining with FIG. 7, for facilitating the upper abutting portion 25 and the lower abutting portion 27 to contact with the upper supporting portion 203 and the lower supporting portion 204 respectively, the width of the upper abutting portion 25 is less than a width of the upper supporting portion 203, the width of the lower abutting portion 27 is less than a width of the lower supporting portion 204. A width of the upper elastic portion 22 is greater than the width of the upper contacting portion 23 and a width of the lower elastic portion 24 is greater than a width of the lower contacting portion 26. The upper spoon-shaped contacting portion 251 is directly over the upper supporting portion 203 and the lower spoon-shaped contacting portion 271 is directly below the lower supporting portion 204.

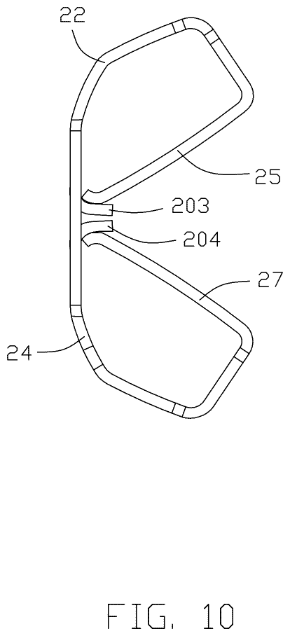

Referring to FIGS. 5, 9, and 10, in order to increase the elasticity of the upper elastic portion 22 and the lower elastic portion 24, the upper elastic portion is provided with an upper opening 220 and comprises an upper vertical portion 221 and an upper inclined portion 222, and the upper opening 220 spans the upper vertical portion 221 and the upper inclined portion 222. Similarly, the lower elastic portion 24 is provided with a lower opening 240 and comprises a lower vertical portion 241 and a lower inclined portion 242, and the lower opening 240 spans the lower vertical portion 241 and the lower inclined portion 242. In the embodiment, the upper vertical portion 221, the lower vertical portion 241 and the vertical plate 200a are in a same vertical plane/plate when the terminal 20 is free. When the terminal is pressed, the upper vertical portion 221 and the upper inclined portion 222 are deformed together as the upper opening 220 spans the upper vertical portion 221 and the upper inclined portion 222 while the lower vertical portion 241 and the lower inclined portion 242 are deformed together as the lower opening 240 spans the lower vertical portion 241 and the lower inclined portion 242. A width of the vertical plate 200a is greater than the width of the upper elastic portion 22 and the width of the lower elastic portion 24, and a width of the slot 210 is larger than a width of the upper opening 220 and a width of the lower opening 240. To facilitate the installation of the terminals, two side edges of the lower elastic portion 24 are provided with a strip connecting portion 243 respectively. As shown in FIG. 10, the width of the upper opening 220 is great than the width of the upper abutting portion 25, and the width of the lower opening 240 is greater than the width of the lower abutting portion 27. The upper abutting portion 25 can be seen from the upper opening 220 and the lower abutting portion 27 can be seen from the lower opening 240 when the terminal 20 is seen from the left-right direction.

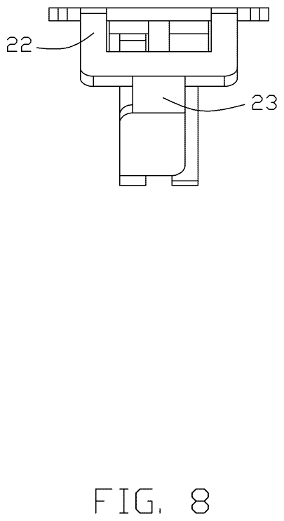

Referring to FIGS. 6-8, the upper elastic portion 22 and the lower elastic portion are in image symmetry along an upper and lower direction. The upper abutting portion 25 and the lower abutting portion 27 are offset and staggered from each other along the width direction of the vertical plate 200a without overlapping, and the upper supporting portion 25 and the lower supporting portion 27 are offset and staggered from each other along the width direction of the vertical plate 200a too. As the upper supporting portion 203 and the lower supporting portion 204 bend from the vertical plate 200a first and then extend horizontally along the right-left direction, the upper abutting portion 25 and the lower abutting portion 27 get easily contact with the upper supporting portion 203 and the lower supporting portion 204 respectively when the upper elastic portion 22 and the lower elastic portion 24 are pressed.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
an insulating housing having an upper face, a lower face, and a plurality of terminal grooves penetrating the upper face and the lower face; and
a plurality of terminals retained in corresponding terminal grooves;
wherein each of the terminals comprises a main portion having a vertical plate, an upper elastic portion, an upper contacting portion, and an upper abutting portion extending upward sequentially from the vertical plate, a lower elastic portion, a lower contacting portion and a lower abutting portion extending downward sequentially from the vertical plate, the upper abutting portion extends downward from the upper contacting portion and the lower abutting portion extends upward from the lower contacting portion, the vertical plate has a left side face and a right side face, an upper supporting portion and a lower supporting portion protrude rightward from the right side face of the vertical plate, and the upper abutting portion abuts against the upper supporting portion and the lower abutting portion abuts against the lower supporting portion when the upper elastic portion and the lower elastic portion are pressed.

2. The electrical connector as claimed in claim 1, wherein both the upper supporting portion and the lower supporting portion bend from the vertical plate first and then extend horizontally along a right direction.

3. The electrical connector as claimed in claim 1, wherein the upper elastic portion extends upward and rightward as a whole from the vertical plate and the upper abutting portion inclines leftward and downward toward the right side face of vertical plate from the upper contacting portion, and the lower elastic portion extends downward and rightward as a whole from the vertical plate and the lower abutting portion inclines leftward and upward toward the right side face of the vertical plate from the lower contacting portion.

4. The electrical connector as claimed in claim 3, wherein the upper abutting portion has an upper spoon-shaped contacting portion bending toward the right side face of the vertical plate, and the lower abutting portion has a lower spoon-shaped contacting portion bending toward the right side face of the vertical plate.

5. The electrical connector as claimed in claim 4, wherein the upper spoon-shaped contacting portion is directly over the upper supporting portion, and the lower spoon-shaped contacting portion is directly below the lower supporting portion.

6. The electrical connector as claimed in claim 1, wherein the upper elastic portion has an upper opening and the lower elastic portion has a lower opening, a width of the upper abutting portion in a front-rear direction perpendicular to a left-right direction is less than a width of the upper opening, and a width of the lower abutting portion is less than a width of the lower opening.

7. The electrical connector as claimed in claim 1, wherein the upper supporting portion is at a higher level relative to the lower supporting portion.

8. The electrical connector as claimed in claim 1, wherein the vertical plate has a slot penetrating the left side face and the right side face thereof, the upper supporting portion extends from an upper edge of the slot and the lower supporting portion extends from a lower edge of the slot.

9. The electrical connector as claimed in claim 1, wherein the upper supporting portion and the lower supporting portion are offset and staggered from each other along a width direction of the vertical plate perpendicular to a left-right direction.

10. An electrical connector comprising:
an insulating housing having an upper face, a lower face, and a plurality of terminal grooves penetrating the upper face and the lower face; and
a plurality of terminals retained in corresponding terminal grooves, each of the terminals comprising a main portion, an upper elastic arm extending from the main portion upward, and a lower elastic arm extending from the main portion downward, the upper elastic arm having an upper contacting portion and an upper abutting portion, the lower elastic arm having a lower contacting portion and a lower abutting portion;
wherein the main portion has an upper supporting portion and a lower supporting portion, both the upper supporting portion and the lower supporting portion bend from a vertical plate of the main portion first and then extend horizontally along a left-right direction perpendicular to the vertical plate, and the upper abutting portion contacts with an upper face of the upper supporting portion and the lower abutting portion contact with a lower face of the lower supporting portion when the upper elastic arm and the lower elastic arm are pressed.

11. The electrical connector as claimed in claim 10, wherein the upper elastic arm has an upper elastic portion, the upper elastic portion, the upper contacting portion, and the upper abutting portion extend upward from the main portion sequentially, the lower elastic arm has a lower elastic portion, and the lower elastic portion, the lower contacting portion, and the lower abutting portion extend downward from the main portion sequentially.

12. The electrical connector as claimed in claim 11, wherein the upper elastic portion extends upward and rightward as a whole from the main portion, and the upper abutting portion inclines leftward and downward from the upper contacting portion toward the upper face of the upper supporting portion.

13. The electrical connector as claimed in claim 12, wherein a rightmost point of the upper elastic arm exceeds a rightmost point of the upper supporting portion in a right direction.

14. The electrical connector as claimed in claim 12, wherein the lower elastic portion extends downward and rightward as a whole from the main portion, and the lower abutting portion inclines leftward and upward from the lower contacting portion toward the lower face of the lower supporting portion.

15. The electrical connector as claimed in claim 14, wherein the upper abutting portion has an upper spoon-shaped contacting portion at a free end thereof for contacting with the upper face of the upper supporting portion, and the lower abutting portion has a lower spoon-shaped contacting portion at a free end thereof for contacting with the lower face of the lower supporting portion.

16. The electrical connector as claimed in claim 11, wherein the upper elastic portion has an upper vertical portion extending upright from the main portion and an upper inclined portion inclining upward and rightward from the upper vertical portion, and the lower elastic portion has a lower vertical portion extending vertically from the main portion and a lower inclined portion inclining downward and rightward from the lower vertical portion.

17. The electrical connector as claimed in claim 16, wherein the upper elastic portion has an upper opening that spans the upper vertical portion and the upper inclined portion, and the lower elastic portion has a lower opening that spans the lower vertical portion and the lower inclined portion.

18. An electrical connector comprising:
an insulating housing having an upper face, a lower face, and a plurality of terminal grooves penetrating the upper face and the lower face; and
a plurality of terminals retained in corresponding terminal grooves;
wherein each of the terminals is stamped from an integral metal plate and comprises a main portion, an upper elastic portion, an upper contacting portion and an upper abutting portion extending upward sequentially from the main portion, a lower elastic portion, a lower contacting portion, and a lower abutting portion extending downward sequentially from the main portion, the upper abutting portion extends downward from the upper contacting portion and the lower abutting portion extends upward from the lower contacting portion, the main portion has an upper supporting portion and a lower supporting potion, the upper abutting portion has an upper spoon-shaped contacting portion at a free end thereof, the lower abutting portion has a lower spoon-shaped contacting portion at a free end thereof, and the upper spoon-shaped contacting portion is directly over the upper supporting portion and the lower spoon-shaped contacting portion is directly below the lower supporting portion.

19. The electrical connector as claimed in claim 18, wherein the main portion has a vertical plate, the upper supporting portion and the lower supporting portion bend and extend from the vertical plate, and the upper spoon-shaped contacting portion contacts with the upper face of the upper abutting portion and the lower spoon-shaped contacting portion contacts with the lower face of the lower abutting portion when the terminal is pressed.

20. The electrical connector as claimed in claim 19, wherein the upper elastic portion extends upward and rightward from the main portion up as a whole, and both the upper supporting portion and the lower supporting bend from the main portion first and then extend horizontally along a left-right direction perpendicular to the vertical plate.
